(19) United States
(12) Patent Application Publication
(10) Pub. No.: US 2005/0079286 A1
(43) Pub. Date: Apr. 14, 2005

(54) Method of applying coatings

(76) Inventors: Alexandr Ivanovich Kashirin, Kaluzhskaya obl. (RU); Oleg Fedorovich Klyuev, Kaluzhskaya obl. (RU); Alexandr Viktorovich Shkodkin, Kaluzhskaya obl. (RU); Timur Valerievich Buzdygar, Kaluzhskaya obl. (RU)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/499,869

(22) PCT Filed: Dec. 20, 2002
(86) PCT No.: PCT/RU02/00543

(30) Foreign Application Priority Data
Dec. 26, 2001 (RU) 2001135048

(51) Int. Cl. B05D 1/02

(52) U.S. Cl. 427/180; 427/421.1

(57) ABSTRACT

A method is intended for applying metal coatings to the surface of articles, specifically during the recovery of shape and dimensions of metal parts as well as during the manufacture and repair of articles which require impermeability increased corrosion resistance, heat resistance and other qualities. The method comprises preliminary heating the compressed air supplying it into the supersonic nozzle, forming a supersonic air flow in the nozzle, supplying into this flow a powder material and directing it to the surface of an article being treated: first the abrasive powder material with a particle size of from 30 to 300 pm being supplied into the supersonic air flow and then the powder material meant for forming the coating. The beneficial effect is achieved by the fact that the stage of surface preparation and that of coating application proper are practically nonseparated in time, which ensures retention of a high degree of activation and cleanliness of the surface to be coated. A significant fact is that the article being treated is not exposed to substantial overall heating, the heating of the article surface is mainly effected in the area where it is necessary to apply the coating. Moreover, one the same equipment is employed which results in significant reduction in the cost and in acceleration of the precess as a whole.

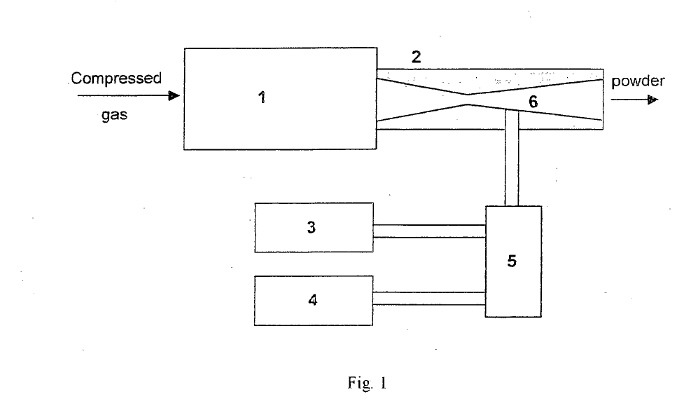

This invention relates to the technology of applying coatings to the surface of articles, and in particular to gas-dynamic methods of applying coatings with the use of an inorganic powder, and it may be employed in different branches of mechanical engineering, particularly during the recovery of shape and dimensions of metal parts, during the manufacture and repair of articles which require impermeability, increased corrosion resistance, heat resistance and other qualities.

The application of metal and metal-ceramic coatings is a well-known method for imparting specific properties, for instance anticorrosive, heat resistant, and others, to the surfaces of parts and articles. Besides, when applying coatings to worn and damaged portions of the parts, one succeeds in recovering the article's surface shape lost in operation or the critical dimensions of the parts and articles. With this method, it is also possible to eliminate defects arising on the part surfaces from the manufacturing stage, such as casting defects.

Among the effective methods of applying metal and metal-ceramic coatings are, gas-dynamic methods. In these methods, a high-velocity flow of small particles is directed to the surface of an article being treated, thus forming a continuous coating. In this case, in order to increase the particle velocity, use is made of compressed gases, predominantly air, without using any combustible. As a result, gas-dynamic methods are more pollution-free and safe in operation than, for example, gas-flame methods.

The most significant characteristics of quality of-the coatings to be applied are their adherence to the base and powder material utilization coefficient (ratio of the material included in the coating to the total amount of the material used).

To enhance the adherence of a coating to the base, the whole procedure of coating application is generally divided into two separate technological processes, namely preparation of the article's surface and coating application proper.

For surface preparation, abrasive blasting of the base surface is commonly used (A. Khasui. Tekhnika Napylenia/Spraying Technique/.Mashinostroenie Publishing House, Moscow. 1975, p.39; RU 2024648; DE 4021467). In this case, an abrasive material is accelerated by compressed air and directed to the surface of an article being treated. As a result, the base surface is cleaned from contaminants and oxides while definite roughness is imparted to it, and activation of the base surface layer occurs. The final result depends on the size of abrasive material particles used, on the velocity they are accelerated to by means of the compressed air, on the particle flow density and on the time of treatment. The disadvantage of this method lies in the fact that such a surface treatment requires the use of the special equipment other than the equipment used for spraying the coatings. This makes the cost of the whole process of applying the coatings more complicated and expensive. Besides, there passes some time from the moment of abrasive blasting, to prepare the surface, to the moment of coating application proper, which brings about the formation of oxides on the treated surface, absorption of contaminants, and with it, surface activation loss. This results in insufficient enhancement of adherence of the coating to the base.

A further prior art method of applying coatings comprises preparation of the article's surface for subsequent coating application by means of preliminary heating this article (A. Khasui. Tekhnika Napylenia/Spraying Technique/.Mashinostroenie Publishing House, Moscow. 1975, p.53; EP 339153). In this case, due to lowering the thermal stresses in the coating being applied its adherence to the base is enhanced. Moreover, in the case of gas-dynamic methods, powder material utilization coefficient is increased (A. P. Alkhimov, S. V. Klinkov, V. F. Kosarev. Investigation of Interaction Between Two-Phase Flow and Heated Surface. Thermal Physics and Aerodynamics. 1998, No.1, pp. 67-73). In practice, this method necessitates added time and energy consumption so as to heat the entire article. Besides, the special equipment is required to effect the heating. This makes the process of coating application more complicated and expensive. Furthermore, during the course of elongated heating the article its surface is additionally oxidized resulting in a reduction in the adherence of the coating to this surface.

Known in the art are methods wherein in order to enhance the adherence of the coating to the base, a flow of metal and ceramic particles is simultaneously directed to the article's surface. For example, a method of producing coatings consisting in accelerating, in a supersonic nozzle by preheated air flow, and applying to the article's surface a powder material which comprises a mechanical mixture of ceramic and metal powders (RU 2038411).

The most similar to the claimed solution is a method consisting in heating the compressed air, supplying it into a supersonic nozzle, forming a supersonic air flow in this nozzle, supplying a powder material into this flow, accelerating this powder material in the nozzle by said supersonic flow and directing it to the surface of an article being treated (RU 2100474). In this method, even when a mechanical mixture of metal and ceramic particles is used as the powder material, these ceramic (abrasive) particles do not interact with the entire surface of the base, since part of it is shielded by the metal particles adhered thereto. Moreover, the size of ceramic (abrasive) particles, which is optimal for forming the coating thickness, turns out to be non-optimal for preparing the base surface. For these reasons, it is not possible to provide the maximum adherence of the coating to the base. To enhance the adherence, additional preliminary abrasive blasting of the surface is required with the use of additional, equipment. This causes an increase in the overall cost of coating application.

The present invention has for its object the enhancement of adherence of coatings produced by a gas-dynamic method with a simultaneous increase in powder material utilization coefficient and increase in efficiency of the process as a whole.

The given object is accomplished by the fact that in the prior art method of applying the coatings,.comprising heating the compressed air, supplying it into a supersonic nozzle and forming a supersonic air flow in this nozzle,-supplying a powder material into this flow, accelerating this powder material in the nozzle by said supersonic flow and directing it to the surface of an article being treated, first an abrasive powder material is supplied into the supersonic flow in the nozzle and then the powder material intended for forming the coating, the particle size of the abrasive powder material being in the range of from 30 to 300 μm.

Alumina, silicon oxide or silicon carbide may be employed as the abrasive material.

Depending on the size and material of the part being treated as well as on the purpose of the coating, it is advisable that the compressed air be heated to a temperature of from 200 to 800° C.

In order to provide an environmentally appropriate method, it is advisable that heating be effected by means of an electric heater.

Depending on the required properties of the coating to be applied, it is advisable that a mechanical mixture of ceramic and metal powders be employed as the powder for forming the coating.

It is advisable that the powders with a particle size of between 1 and 100 μm be used as the metal powder.

It is advisable that the powders with a particle size of between 1 and 100 μm be used as the ceramic powder.

To simplify the equipment, it is advisable that the supersonic flow in the nozzle be formed so that the static pressure in it should be below the atmospheric one.

The method of the present invention is distinguished from the prior art method by the fact that first the abrasive powder material with a particle size of from 30 to 300 μm is supplied into the supersonic air flow and then the powder material meant for forming the coating.

The gist of the method in accordance with the invention resides in the following.

It is known that abrasive blasting and heating of the base surface enhance the adherence and powder material utilization coefficient in the case of gas-dynamic method of applying the coating.

During the supply of the abrasive powder material the particles of this material, while interacting with the base surface being treated, clean-the surface from oxides and other contaminants, activate the base surface and form the developed microrelief of the surface. At the same time, the simultaneous heating of the surface of an article being treated is made by means of a heated air flow from the nozzle directly in the area of spraying the coating. Thereafter, the powder material meant for forming the coating is supplied into the supersonic air flow in the nozzle. The high-velocity particles of this powder material strike the base, they are partially deformed and adhere to the base surface. As this takes place, these particles interact with the roughened, developed, activated and heated surface, which results in substantial enhancement of adherence of the coating to the base and in an increase in powder material utilization coefficient. The beneficial effect is achieved owing to the fact that the stage of surface preparation and that of coating application proper are practically non-separated in time. This ensures retention of a high degree of activation and cleanliness of the surface to be coated, and also the optimal degree of surface roughness. Besides, a significant fact is that the article to be treated is not subjected to substantial overall heating. In this case, the heating of the article surface is mainly effected in the area where it is necessary to apply the coating. Moreover, for both stages of coating application, i.e. surface preparation and coating application proper, one and the same equipment is employed. This brings about a significant reduction in the cost of the equipment and speeds up the whole process.

The analysis of existing gas-dynamic methods of coating application has shown that there are no prior art methods comprising the stage of optimal surface preparation and that of coating application proper to be realized using one and the same technological process and one and the same equipment.

For the process as a whole, it turned out to be significant to employ the abrasive powder material having a specified particle size. With a particle size above 300 μm, the particles are insufficiently accelerated by the supersonic air flow. Besides, the probability of their impact on the nozzle walls increases, which causes particle deceleration and extensive nozzle wear. This results in a reduction in efficiency of base surface treatment and in an increase in the time and amount of the powder material required for the treatment. In the case of abrasive powder material particles of a size below 30 μm, the base surface cleaning from dense oxides and contaminants is hindered due to their low mass. Moreover, the low degree of the base surface roughness obtained fails to ensure the maximum enhancement of adherence of the coating to the base.

This method can be carried out using, for instance, DYMET-type equipment developed and manufactured by Obninsk Center of Powder Spraying. The equipment is schematically illustrated in the figure below. The apparatus comprises the compressed air heater 1 having an outlet connected to the supersonic nozzle 2, two powder feeders 3 and 4, and the switching device 5 which provides alternate connection of powder feeder outlets to the nozzle portion 6 downstream of the throat. This equipment has been used in all the examples of specific application of this method. In the process, static pressure ranging from 0.8 to 0.9 bar was maintained in the supersonic air flow in the nozzle at the point of powder feeding.

The method in accordance with the invention is illustrated by the following specific examples.

### EXAMPLE 1

An aluminum-zinc coating with a thickness of from 200 to 400 μm was applied to the cast-iron base. At the stage of surface preparation, alumina (corundum) abrasive powder material with a particle size of from 150 to 200 μm was employed. Following its supply into the nozzle, surface cleaning from oxide film and appearance of surface roughness were observed.

The powder material meant for forming the coating comprised aluminum powder with a particle size of from 1 to 50 μm, zinc powder with a particle size of from 1 to 100 μm and silicon carbide powder with a particle size of from 1 to 63 μm. The compressed air prior to the supply into the supersonic nozzle was heated up to a temperature as high as 300° C. The adherence of the coating to the base turned out to be equal to 4.5 MPa, whereas during preliminary standard sand-blasting of the surface carried out for comparison purpose it made up 3.5 MPa.

### EXAMPLE 2

An aluminum coating with a thickness of from 50 to 100 μm was applied to the steel base. For surface preparation, silicon carbide abrasive powder material with a particle size of from 150 to 200 μm was employed. To apply a coating, a mixture of aluminum powder with a particle size of from 1 to 20 μm and silicon carbide powder with a particle size of from 1 to 40 μm was employed. The compressed air prior to the supply into the supersonic nozzle was heated up to a temperature as high as 500° C. Powder material utilization coefficient made up 25%, whereas during the coating application without the stage of surface preparation, i.e. without preliminary heating the base, it made up 18%.

### EXAMPLE 3

Using the method in accordance with the invention, an aluminum-zinc coating having a thickness of from 100 to 200 μm was applied to the steel base. The compressed air prior to the supply into the supersonic nozzle was heated up to a temperature as high as 400° C. To apply a coating, a mechanical mixture of powders was used having the following particle size: aluminum—of from 1 to 50 μm, zinc—of from 1 to 45 μm, and corundum—of from 1 to 40 μm. For surface preparation, alumina abrasive powder material was employed. The adherence to the base turned out to be as follows: with a particle size of abrasive powder material of from 30 to 63 μm it made up 4 MPa, with a particle size of abrasive powder material of from 150 to 200 μm it made up 5 MPa, with a particle size of abrasive powder material of from 200 to 300 μm it made up 4.5 MPa. It can be seen that the best result has been achieved with a particle size of abrasive powder material ranging from 30 to 300 μm.

The above specific examples have shown that the method in accordance with the invention enables one to produce the coatings characterized in enhanced adherence to the base and increased coefficient of powder material utilization.

It is advisable that hard oxides or carbides such as alumina, silicon oxide or silicon carbide be used as the abrasive powder material.

Depending on the size and material of the part being treated, as well as on the composition and purpose of the coating, it is advisable that the heating of compressed air be effected to a temperature of from 200 to 800° C. At a temperature below 200° C., coefficient of utilization of the powder material meant for forming the coating is significantly reduced, and with it, the efficiency of the process as a whole. At a temperature above 200° C., the probability of powder material sticking to the nozzle inner walls considerably increases. The thermal effect upon the base also increases considerably. Besides, it is technically complicated to accomplish electric heating for heating the compressed air flow to higher temperatures.

To ensure ecological purity of the coating process, it is advisable that the heating of compressed air be effected by means of an electric heater.

Depending on the required characteristics of the coating to be applied, it is advisable that a mechanical mixture of ceramic and metal powders be used as the powder material meant for forming the coating. In particular, the presence of ceramic particles along with the metal ones in the powder material reduces porosity of the coatings and improves their breaking strength.

It is advisable that the powders with a particle size of from 1 to 100 μm be used as the ceramic powder in the powder material composition meant for forming the coating. The particles of a size above 100 μm provide a significant abrasive effect and reduce powder material utilization coefficient while cutting off some of the metal particles adhered. The particles having a size below 1 μm are easily decelerated in the decelerated air layer in front of the base, and they do not interact with the base or the coating.

It is advisable that the powders with a particle size of from 1 to 100 μm be employed as the metal powder in the powder material composition meant for forming the coating. The particles of a size above 100 μm are not accelerated to a high velocity in the nozzle, while the particles with a size below 1 μm are easily decelerated in the decelerated air layer in front of the base. In both cases, the powder material utilization coefficient is significantly reduced.

To simplify the equipment and to make the device for supplying the powder material into the supersonic flow in the nozzle permeable, it is advisable to form the supersonic flow in the nozzle so that the static pressure in the area of supplying the powder material should be below the atmospheric pressure.

1. A method of applying a coating which comprises heating the compressed air, supplying it into a supersonic nozzle, forming a supersonic air flow in this nozzle, supplying an abrasive powder material into this flow, accelerating this powder material in the nozzle by said supersonic flow, and directing it to the surface of an article being treated, subsequent supplying into said supersonic air flow in the nozzle a powder material meant for forming the coating, accelerating this powder material in the nozzle by said supersonic flow, and directing it to the surface of the article being treated; said abrasive powder material having a particle size of from 30 to 300 μm.

2. A method according to claim 1 wherein the abrasive powder material is alumina and/or silicon oxide, and/or silicon carbide.

3. A method according to claim 1 wherein the compressed air is heated to a temperature of from 200 to 800° C.

4. A method according to claim 1 wherein the heating of the compressed air is effected by means of an electric heater.

5. A method according to claim 1 wherein the powder meant for forming the coating is a mechanical mixture of ceramic and metal powders.

6. A method according to claim 5 wherein the metal powder is a powder with a particle size of from 1 to 100 μm.

7. A method according to claim 5 wherein the ceramic powder is a powder with a particle size of from 1 to 100 μm.

8. A method according to claim 1 wherein the supersonic air flow in the nozzle is formed having the static pressure below the atmospheric one.
